(19) United States
(12) Patent Application Publication
(10) Pub. No.: US 2022/0317632 A1
(43) Pub. Date: Oct. 6, 2022

(54) HOLOGRAPH-PROJECTING WATCH DEVICES AND METHODS THEREIN

(71) Applicant: Eytan Siboni, Haifa (IL)

(72) Inventor: Eytan Siboni, Haifa (IL)

(21) Appl. No.: 17/218,205

(22) Filed: Mar. 31, 2021

(51) Int. Cl. G04G 9/04; G03H 1/00; G04G 17/04

(52) U.S. Cl. CPC G04G 9/047; G03H 1/0005; G04G 17/045; G03H 2001/0061

(57) ABSTRACT

The present invention discloses devices for projecting holographic content from a watch and methods therein. Devices include: a watch base for housing the watch; an opaque watch face attached to the base; a transparent watch cover for protecting the face; a light wand having a series of controllable light-emitting elements configured to project the holographic content, wherein the series is disposed on the wand such that light emitted from the elements is projected primarily toward the cover, the wand is disposed: mostly parallel to the surfaces of the face and cover; and between the face and cover with a spacing greater than about 40% of a face/cover gap adapted to produce suitable, projected holographic content free from distortion caused by the proximity of the face to the wand; and a spinning axis for mounting the wand, configured for rotating in order to spin the wand for projecting the holographic content.

### FIELD AND BACKGROUND OF THE INVENTION

The present invention relates to holograph-projecting watch devices and methods therein.

Over the years, watches have been produced to provide an increasing number of functional features. While such features have primarily been utilitarian, other features have been introduced to enhance the watch's attractive qualities, such as incorporating lights into the display.

Recently, an additional feature of the smartwatch market has been to provide dynamic content such as ancillary information (e.g., weather, call contact information, appointment schedules, and events), as well as content meant for viewing entertainment. However, such dynamic content has been limited to the domain of the smartwatch display screen. There has been no capability which allows such dynamic content to be incorporated into a traditional watch.

Likewise, the advent of fidget spinners as a popular casual toy has highlighted the point that individuals like to play with gadgets in order to occupy their time. However, while fidget spinners have been developed to provide a rudimentary display of content, such content has not been displayed in a more engaging manner.

Moreover, such fidget spinners have a dedicated purpose which makes their use somewhat short-lived. The only reason one carries such a spinner is in order to play with it exclusively—it serves no other function.

In the realm of holography, the interest in projecting dynamic holographic content is rapidly increasing. While advances are constantly being made, an obstacle to mass acceptance of such holograph-projecting content is the appeal of the device in which the capability is embodied in. That is, while making a compelling statement for attracting interest and attention, holographic-projecting devices, like fidget spinners, generally serve a singular or primary purpose of projecting the holographic content. Thus, such devices lack in their ability to attract users to engage with the dynamic content in a utilitarian way as with the traditional watch or smartwatch.

It would be desirable to have holograph-projecting watch devices and methods therein. Such devices and methods therein would, inter alia, overcome the various limitations mentioned above.

### SUMMARY

It is the purpose of the present invention to provide holograph-projecting watch devices and methods therein.

It is noted that the term “exemplary” is used herein to refer to examples of embodiments and/or implementations, and is not meant to necessarily convey a more-desirable use-case. Similarly, the terms “alternative” and “alternatively” are used herein to refer to an example out of an assortment of contemplated embodiments and/or implementations, and is not meant to necessarily convey a more-desirable use-case. Therefore, it is understood from the above that “exemplary” and “alternative” may be applied herein to multiple embodiments and/or implementations. Various combinations of such alternative and/or exemplary embodiments are also contemplated herein.

Embodiments of the present invention provide a holograph-projecting watch device, capable of projecting 3D holographic content above a watch's viewing surface. The watch device may be incorporated into an optional spinner casing to project the holographic content upon manual and/or motorized rotation of an LED light wand.

Therefore, according to the present invention, there is provided for the first time a device for projecting holographic content from a watch, the device including: (a) a watch base for housing the watch; (b) an opaque watch face attached to the watch base; (c) a transparent watch cover for protecting the opaque watch face; (d) a light wand having a series of controllable light-emitting elements configured to project the holographic content, wherein the series is disposed on the light wand such that light emitted from the elements is projected primarily toward the transparent watch cover, the light wand is disposed: (i) mostly parallel to the surface of the opaque watch face and the surface of the transparent watch cover; and (ii) between the opaque watch face and the transparent watch cover with a wand/face spacing, representing a positional distance between the opaque watch face and the transparent watch cover, that is greater than about 40% of a face/cover gap, representing a total available distance between the opaque watch face and the transparent watch cover, in order to be adapted to produce suitable, projected holographic content, from the holographic content, that is free from any distortion caused by the proximity of the opaque watch face to the light wand; and (e) a spinning axis for mounting the light wand, the spinning axis configured for rotating in order to spin the light wand for projecting the holographic content.

Alternatively, only the light wand is configured to rotate on the spinning axis, and the light wand is configured to rotate in accordance with components in the watch base.

Alternatively, the spinning axis is configured to be automatically spun by a motorized component in the watch base.

Alternatively, the device further includes: (f) a spinner casing in the watch base configured to manually spin the spinning axis.

Most alternatively, the spinner casing is configured to be automatically spun by a motorized component in the watch base.

Alternatively, the suitable, projected holographic content is content selected from the group consisting of: image content, data content, time content, date content, weather content, animation content, and video content.

Alternatively, the device further includes: (f) at least one watch hand for indicating a selected symbol on the opaque watch face, at least one watch hand being mounted coaxially on the spinning axis, and at least one watch hand being adapted to rotate independently of the spinning axis.

Alternatively, the light wand is configured to be programmed for selective activation according to at least one criterion, and the series is configured to be programmed for selection of the suitable, projected holographic content.

Alternatively, the device further includes: (f) a programmable memory for storing content and instructions for configuring operation of the light wand, configuring operation of the series, and selecting of the suitable, projected holographic content.

Alternatively, the light-emitting elements are light-emitting diodes (LEDs).

Alternatively, the light wand includes at least two stacked spokes, each stacked spoke has a series of controllable light-emitting elements configured to project the holographic content, and the wand/face spacing is determined from a closest stacked spoke of the stacked spokes that is closest to the opaque watch face.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A depicts a side view of a holograph-projecting watch device, according to embodiments of the present invention;

FIG. 1B depicts a side view of the holograph-projecting watch device of FIG. 1A with the wand/face gap maximized, according to embodiments of the present invention;

FIG. 2 depicts a side view of the holograph-projecting watch device of FIG. 1A with traditional watch hands below the light wand, according to embodiments of the present invention;

FIG. 3 depicts a side view of the holograph-projecting watch device of FIG. 1A with an exemplary holographic image being depicted above the light wand, according to embodiments of the present invention;

FIG. 4A depicts a top view of the holograph-projecting watch device of FIG. 1A with an alternate, 2-spoked, light wand, according to embodiments of the present invention;

FIG. 4B depicts a top view of the holograph-projecting watch device of FIG. 1A with an alternate, 3-spoked, light wand, according to embodiments of the present invention;

FIG. 4C depicts a top view of the holograph-projecting watch device of FIG. 1A with an alternate, 4-spoked, light wand, according to embodiments of the present invention;

FIG. 4D depicts a side view of the holograph-projecting watch device of FIG. 1A with an alternate, stacked, multi-spoked, light wand, according to embodiments of the present invention.

### DESCRIPTION OF THE ILLUSTRATIVE EMBODIMENTS

The present invention relates to holograph-projecting watch devices and methods therein. The principles and operation for providing such devices and methods, according to the present invention, may be better understood with reference to the accompanying description and the drawings.

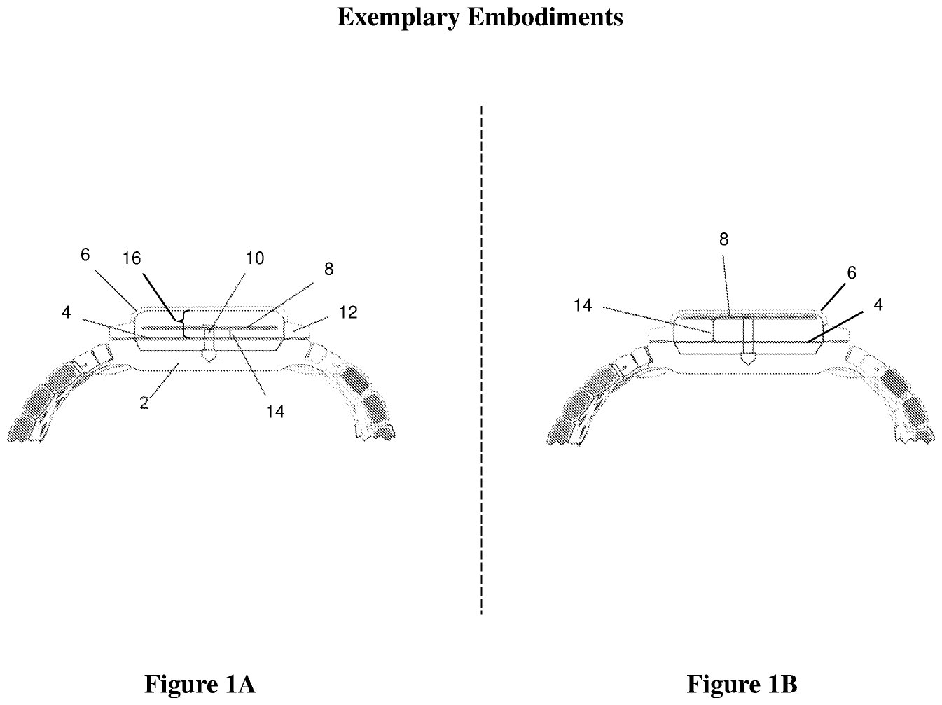

Referring to the drawings, FIG. 1A depicts a side view of a holograph-projecting watch device, according to embodiments of the present invention. A watch is shown having a watch base 2 on which is mounted an opaque watch face 4 and a transparent watch cover 6. Opaque watch face 4 is rigidly attached to watch base 2. A light wand 8 is configured to be spun on a rotatable spinning axis 10, automatically driven by a motorized component (not shown) in watch base 2. In some embodiments, an optional spinner casing 12 is configured to rotate light wand 8, on spinning axis 10, above opaque watch face 4. In such embodiments, spinner casing 12 can be manually driven by a user spinning optional spinner casing 12, and/or automatically driven by a motorized component (not shown) in watch base 2.

In other embodiments, only light wand 8 rotates on spinning axis 10 (e.g., axle mounted in a bearing). A wand/face spacing 14 is shown indicating the spacing between light wand 8 and opaque watch face 4. In such embodiments, optional spinner casing 12 is a stationary casing with light wand 8 being automatically driven by a motorized component (not shown) in watch base 2. In both embodiments described, light wand 8 is configured to rotate freely on spinning axis 10. In motorized embodiments, such rotation is regulated. Light wand 8 includes a series of controllable light-emitting elements (e.g., LEDs) which can be configured to project holographic content.

A face/cover gap 16 is shown indicating the gap from opaque watch face 4 to transparent watch cover 6). While in principle face/cover gap 16 represents the total range of height positions for light wand 8 (i.e., wand/face spacing 14) within the constraints of allowing light wand 8 to rotate freely without contacting other parts of the watch housing (e.g., transparent watch cover 6), additional constraints are imposed for producing a suitable holographic projection as described below.

FIG. 1B depicts a side view of the holograph-projecting watch device of FIG. 1A with the wand/face gap maximized, according to embodiments of the present invention. Wand/face spacing 14 is shown maximized (i.e., the farthest suitable distance from opaque watch face 4 available) to raise light wand 8 above opaque watch face 4 as close as possible to transparent watch cover 6.

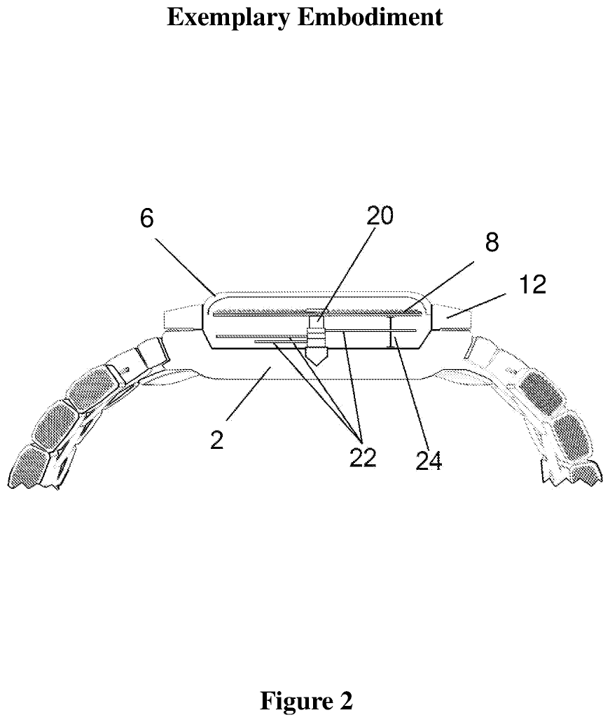

FIG. 2 depicts a side view of the holograph-projecting watch device of FIG. 1A with traditional watch hands below the light wand, according to embodiments of the present invention. A spinning axis 20 is shown adapted to accommodate light wand 8 as well as traditional watch hands 22 such as hour, minute, and second hands. A wand/face spacing 24 is shown adapted to raise light wand 8 above watch hands 22 in order to prevent interference of light wand 8 with the rotation of watch hands 22.

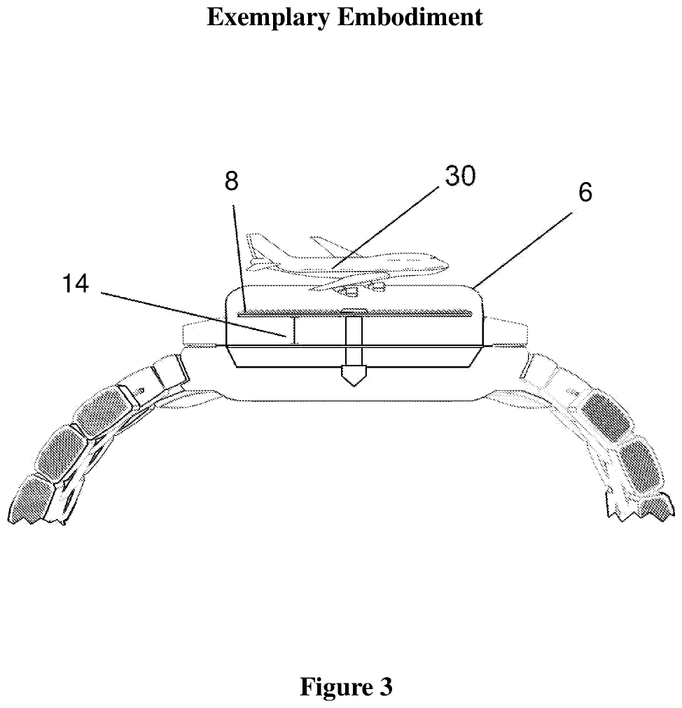

FIG. 3 depicts a side view of the holograph-projecting watch device of FIG. 1A with an exemplary holographic image being depicted above the light wand, according to embodiments of the present invention. Projected holographic content 30 (e.g., images, data (such as time, date, and weather information), animations, and/or video) is shown projected by light wand 8.

It is noted that projected holographic content 30 can generally only be seen by an observer from a top view (i.e., perpendicular to transparent watch cover 6), or at perspectives having various angles deviating from such a top view. Projected holographic content 30 is shown in FIG. 3 from a side view in order to provide clarity with regard to the relation of projected holographic content 30 to transparent watch cover 6, light wand 8, and wand/face spacing 14.

As mentioned above with regard to FIG. 1A, producing a suitable holographic projection imposes additional constraints on the range of available height positions for light wand 8 (i.e., wand/face spacing 14). If wand/face spacing 14 is not sufficient, projected holographic content 30 of FIG. 3 will be distorted in appearance, displayed as blurry, partially obscured, flat (i.e., two dimensional), and/or lacking depth (i.e., not three dimensional). This is due to the opacity of opaque watch face 4 creating a “background distortion” (i.e., the “background” of light wand 8 induces the distortion, not a background in projected holographic content 30). Such distortion occurs in the generation of projected holographic content 30 if the proximity of opaque watch face 4 to light wand 8 is too close.

A useful measurement is to express wand/face spacing 14 as a percentage of face/cover gap 16, referred to as a “wand-spacing range.” Given that face/cover gap 16 places a finite limitation on the maximum height position of light wand 8 in order to prevent contact with other housing elements, the maximum value for the wand-spacing range is 100% (or nearly 100%) in order to achieve a desirable projection by generating projected holographic content 30 without any distortion. A threshold minimum value for the wand-spacing range is affected by opaque watch face 4 as described above, and is generally not trivial to determine.

Such a threshold minimum value for the wand-spacing range is a significant technical hurdle that has not been previously encountered. Distortions in the projection of projected holographic content 30, caused by light interference with opaque watch face 4, only occur due to close positioning of light wand 8 to opaque watch face 4, which is not a typical constraint found in most holographic applications. If light wand 8 is not positioned accordingly, a suitable 3D holographic projection will not be produced. That is, the proper positioning of light wand 8 is an essential and critical parameter to obtaining a proper holographic projection.

Experimental prototyping was used to determine the threshold minimum value for the wand-spacing range. Such assessments led to the conclusion that a wand-spacing range of less than about 40% of the total available gap (i.e., face/cover gap 16) produces improper, poor, and/or indiscernible projections.

It is noted that the interposition of transparent watch cover 6 between light wand 8 and projected holographic content 30 does not create any technical problems for displaying projected holographic content 30. Thus, projected holographic content 30 can even extend below transparent watch cover 6.

Light wand 8 can be programmed to edit the selection of projected holographic content 30 and/or to edit the display of projected holographic content 30 under various criteria for activation. Selection of projected holographic content 30 and activation criteria can be performed from a software application running on a PC or smartphone which can download the configuration data to watch base 2. In addition or alternatively, such setting selections can be performed by activation of adjustment buttons (not shown) located on watch base 2.

Such configuration data can be stored, for example, in a memory module (not shown) located in watch base 2. Watch base 2 can also house other peripheral components (not shown) such as communications modules (e.g., WiFi and Bluetooth), an interface connector (e.g., micro-USB), a charging connector, a spinner motor, a spinning-axis bearing, and standard watch elements to operate watch hands (hour, minute, and second), chronograph, and/or a date indicator.

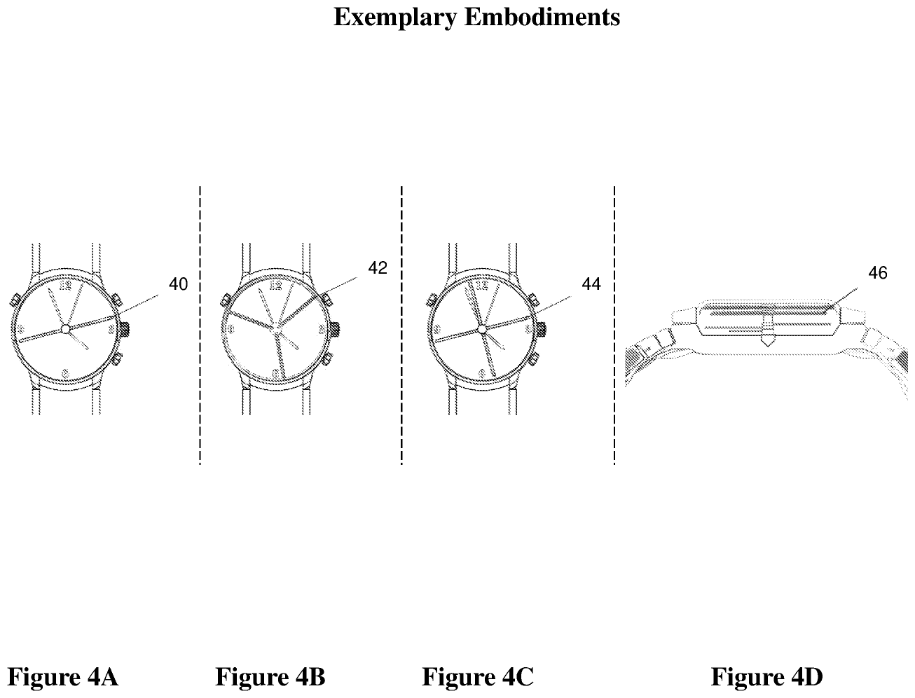

FIG. 4A depicts a top view of the holograph-projecting watch device of FIG. 1A with an alternate, 2-spoked, light wand, according to embodiments of the present invention. An alternate, 2-spoked, light wand 40 is shown.

FIG. 4B depicts a top view of the holograph-projecting watch device of FIG. 1A with an alternate, 3-spoked, light wand, according to embodiments of the present invention. An alternate, 3-spoked, light wand 42 is shown.

FIG. 4C depicts a top view of the holograph-projecting watch device of FIG. 1A with an alternate, 4-spoked, light wand, according to embodiments of the present invention. An alternate, 4-spoked, light wand 44 is shown.

FIG. 4D depicts a side view of the holograph-projecting watch device of FIG. 1A with an alternate, stacked, multi-spoked, light wand, according to embodiments of the present invention. An alternate, stacked, multi-spoked, light wand 46 is shown. In such embodiments, the wand/face spacing (not shown) would be optimized from the lowest light-wand spoke in the “stack” of light wand 46.

While the present invention has been described with respect to a limited number of embodiments, it will be appreciated that many variations, modifications, equivalent structural elements, combinations, sub-combinations, and other applications of the present invention may be made.

What is claimed is:

1. A device for projecting holographic content from a watch, the device comprising:
(a) a watch base for housing the watch;
(b) an opaque watch face attached to said watch base;
(c) a transparent watch cover for protecting said opaque watch face;
(d) a light wand having a series of controllable light-emitting elements configured to project the holographic content, wherein said series is disposed on said light wand such that light emitted from said elements is projected primarily toward said transparent watch cover, said light wand is disposed:
(i) mostly parallel to the surface of said opaque watch face and the surface of said transparent watch cover; and
(ii) between said opaque watch face and said transparent watch cover with a wand/face spacing, representing a positional distance between said opaque watch face and said transparent watch cover, that is greater than about 40% of a face/cover gap, representing a total available distance between said opaque watch face and said transparent watch cover, in order to be adapted to produce suitable, projected holographic content, from the holographic content, that is free from any distortion caused by the proximity of said opaque watch face to said light wand; and
(e) a spinning axis for mounting said light wand, said spinning axis configured for rotating in order to spin said light wand for projecting the holographic content.

2. The device of claim 1, wherein only said light wand is configured to rotate on said spinning axis, and wherein said light wand is configured to rotate in accordance with components in said watch base.

3. The device of claim 1, wherein said spinning axis is configured to be automatically spun by a motorized component in said watch base.

4. The device of claim 1, the device further comprising:
(f) a spinner casing in said watch base configured to manually spin said spinning axis.

5. The device of claim 4, wherein said spinner casing is configured to be automatically spun by a motorized component in said watch base.

6. The device of claim 1, wherein said suitable, projected holographic content is content selected from the group consisting of: image content, data content, time content, date content, weather content, animation content, and video content.

7. The device of claim 1, the device further comprising:
(f) at least one watch hand for indicating a selected symbol on said opaque watch face, said at least one watch hand being mounted coaxially on said spinning axis, and said at least one watch hand being adapted to rotate independently of said spinning axis.

8. The device of claim 1, wherein said light wand is configured to be programmed for selective activation according to at least one criterion, and wherein said series is configured to be programmed for selection of said suitable, projected holographic content.

9. The device of claim 8, the device further comprising:
(f) a programmable memory for storing content and instructions for configuring operation of said light wand, configuring operation of said series, and selecting of said suitable, projected holographic content.

10. The device of claim 1, wherein said light-emitting elements are light-emitting diodes (LEDs).

11. The device of claim 1, wherein said light wand includes at least two stacked spokes, wherein each said at least two stacked spokes has a series of controllable light-emitting elements configured to project the holographic content, and wherein said wand/face spacing is determined from a closest stacked spoke of said at least two stacked spokes that is closest to said opaque watch face.
